(19) United States
(12) Patent Application Publication
(10) Pub. No.: US 2007/0064540 A1
(43) Pub. Date: Mar. 22, 2007

(54) Alarm clock

(76) Inventor: Michael A. Barnett, Myrtle Point, OR (US)

Correspondence Address: JAMES RAY & ASSOCIATES, 2640 PITCAIRN ROAD, MONROEVILLE, PA, 15146, US

(21) Appl. No.: 11/523,234

(22) Filed: Sep. 19, 2006

Related U.S. Application Data
(60) Provisional application No. 60/718,444, filed on Sep. 19, 2005.

(51) Int. Cl. G04C 21/00; G04B 23/02; G04C 23/00

(52) U.S. Cl. 368/73

(57) ABSTRACT

An alarm clock is provided which is a stylish and whimsical alternative to the ordinary alarm clock that produces an exciting and new sound to awaken to each day. The alarm clock comprises a housing, a clock mechanism, and a clock display face contained within the housing. A power source is provided for powering the clock. The clock mechanism includes a signal generating device causing the clock to emit a predetermined alarm sound at the predetermined wake-up time. The alarm clock is capable of changing this predetermined alarm sound to one of a predetermined series of different sounds to produce a varying and/or new sound based on a particular theme. An example of this theme can be a wildlife theme having a series of sounds that emulate those of animals in the wild. The clock can be designed to correspond with the habitat of these animals.

### CROSS-REFERENCES TO RELATED APPLICATIONS

This application claims priority from provisional application Ser. No. 60/718,444, filed Sep. 19, 2005

### FIELD OF THE INVENTION

The present invention relates, in general, to an alarm clock and, more particularly, to an alarm clock which provides users with an exciting and new sound to awaken to each day.

### BACKGROUND OF THE INVENTION

Alarm clocks that emit annoying buzzing and beeping sounds are common appliances found in most every household for waking users from sleep at a predetermined time each day. Although these sounds are annoying, users often become accustomed to the sounds of standard alarm clocks and over time, become immune to the alarm. This results in the user ignoring or sleeping through the alarm or turning off the alarm in their sleep without fully waking.

Novelty alarm clocks have been developed which can emit alarm sounds other than the ordinary buzzing and beeping sounds. One such alarm clock is disclosed in U.S. Pat. No. 4,730,284, which shows an alarm clock in the shape of an animal, and a sound generating circuit which emits the sound of that particular animal according to a set predetermined time. A disadvantage of this type of alarm clock is that, similar to standard alarm clocks, the user can eventually become immune to the sound of the particular animal.

There is a need in the art for an alarm clock that can emit one or more of a series of sounds to awaken a user while preventing the user to become immune to a particular sound. There is a further need in the art for an alarm clock that is based on a particular theme, corresponding with a particular interest/hobby of the consumer, and can emit a series of sounds from this theme, such as a series of wildlife sounds.

### OBJECTS OF THE INVENTION

It is therefore an object of the invention to provide a stylish and whimsical alternative to the ordinary clock/alarm clock.

It is still yet another object of the invention to provide an alarm clock which replaces the annoying alarm sounds of common alarm clocks with pleasing sounds.

It is yet another object of the invention to provide an alarm clock which is based on a particular theme of interest to the consumer.

It is still yet another object of the invention to provide an alarm clock which allows for the selection of a series of alarm sounds so as to provide variety and reduce oversleeping.

It is an even further object of the invention to provide an alarm clock which allows for the rotation through a series of sounds.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the attached drawing Figures and with the appended claims.

### SUMMARY OF THE INVENTION

Briefly, and in accordance with the forgoing objects, the invention comprises an alarm clock which is a stylish and whimsical alternative to the ordinary alarm clock that provides an exciting and new sound to awaken to each day. The alarm clock comprises a housing, a clock mechanism, and a clock display face contained within the housing. The clock mechanism includes means to generate a signal at the predetermined wake-up time. A sound generating circuit is contained within the housing and connected to the clock mechanism to generate the predetermined sound at the predetermined time as controlled by the clock mechanism. Means are associated with the sound generating circuit for changing the predetermined sound to one of a predetermined series of different sounds, and a power source is associated with the clock mechanism and the sound generating circuit for operating the alarm clock.

### BRIEF DESCRIPTION OF THE DRAWINGS

FIG. 1 shows a front perspective view of the alarm clock of the invention.

FIG. 2 shows a back view of the alarm clock of the invention including the power source(s) for the clock.

FIG. 3 shows a top perspective view of the alarm clock of the invention including the dials indicating the available functions of the alarm clock.

### DETAILED DESCRIPTION OF THE INVENTION

Before describing the invention in detail, the reader is advised that, for the sake of clarity and understanding, identical components having identical functions have been marked where possible with the same reference numerals in each of the Figures provided in this document.

Now reference is made to the Figures that show an alarm clock, generally indicated as 10, for emitting a predetermined sound alarm according to a predetermined time, such as a wake-up time. It is noted that the Figures show an alarm clock based upon a wildlife theme, however, one having ordinary skill in the art would recognize that a variety of themes can be used in the design of the alarm clock of the invention.

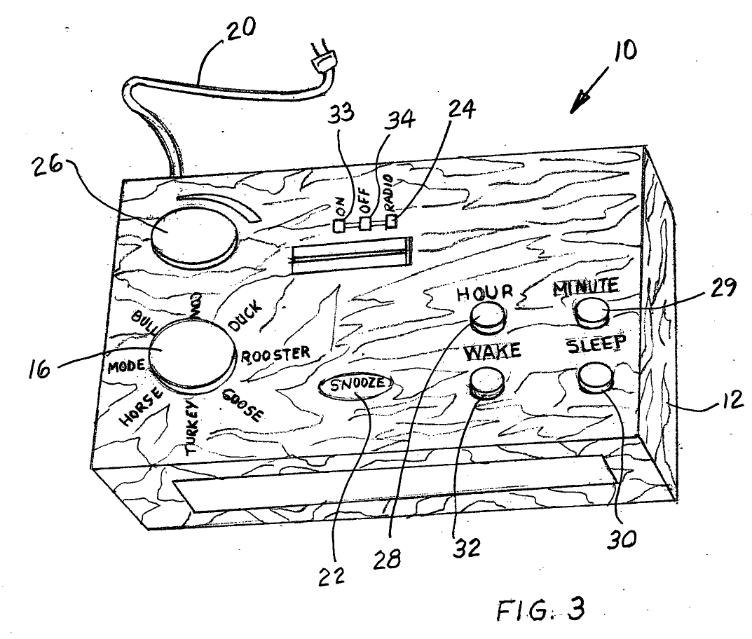

The alarm clock 10 comprises a housing 12. A clock mechanism and clock display face 14 is contained within the housing 12. The time in the clock display face 14 will illuminate as in standard alarm clock designs. The clock mechanism 14 includes means to generate a signal according to the predetermined time. A sound generating circuit is contained within the housing 12 and connected to the clock mechanism 14 to generate the predetermined sound at the predetermined time as controlled by the clock mechanism 14. This sound generating circuit can be any well-known circuit, such as disclosed in U.S. Pat. No. 4,730,284 which is hereby incorporated by reference thereto. Means are associated with the sound generating circuit for changing the predetermined sound to one of a predetermined series of sounds. As shown in FIG. 3, this means associated with the sound generating circuit for changing the predetermined sound to one of the predetermined series of sounds comprises a knob 16 for manually selecting a predetermined sound.

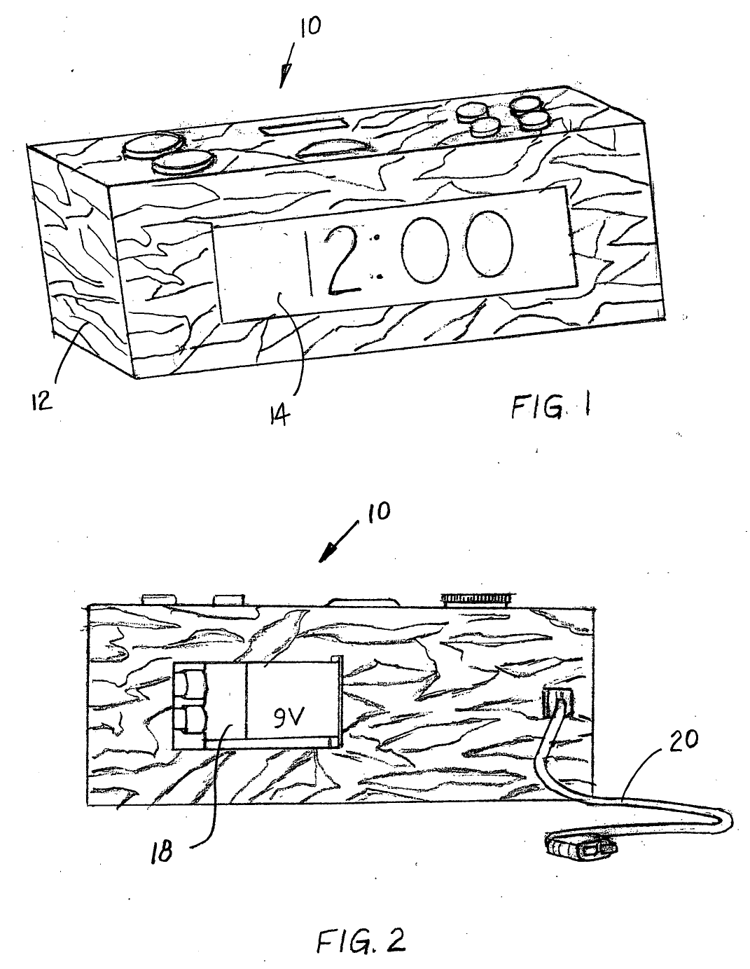

A power source is associated with the clock mechanism and the sound generating circuit for operating the alarm clock 10. As shown in FIG. 2, this power source can comprise any well-known means such as at least one battery system 18, such as a 9-volt battery or a power cord 20 capable of connecting with an electrical outlet. Preferably, a combination of a power cord 20 connected with an electrical outlet and a back-up battery system 18 are provided wherein the battery system 18 is capable of being activated should an interruption of electrical power occur.

The alarm clock of the invention can also contain a well-known means for disabling the alarm sound for a predetermined interval of time and means for reactivating the alarm sound at the conclusion of this interval of time. This well known disabling/reactivating means can comprise a snooze button 22 associated with a timing circuit. So as to avoid the user's immunity to a particular sound, the alarm clock of the invention can include means for automatically rolling through the predetermined series of sounds after each successive predetermined time interval. This means can comprise, for example, a microprocessor chip embedded within the housing 12 for automatically switching through the series of sounds.

Other well known feature which can be included in the alarm clock of the invention include an AM/FM radio 24 located within the housing 12, a volume control button 26 for controlling the volume of the alarm and/or radio, hour/minute buttons 28, 29 for changing the predetermined time of the alarm sound 30 and/or the time of the clock mechanism 32 itself and on/off buttons 33, 34 for the alarm. Additionally, a well known illuminating means, such as a light of LED may be provided for viewing of the clock display face 14 in the dark.

As discussed above, it would be desirable to design the alarm clock of the present invention around a central theme. As illustrated in the drawings, this theme can include a wildlife theme. This theme would be desirable for hunters, wildlife lovers, and anyone else who likes the call of the wild. This clock can be camouflage in color and design and can be made to emit different animal sounds to suit the individual user's preference, such as elk, bear, moose, deer, turkey, chucker, pheasant, owl, geese, duck, loon, quail, lion, elephant, hyena, coyote, wolf, cougar, whale, seal, walrus, dolphin, and the like. The color and/or design of the housing of the clock can closely resemble the habitat of the selected animal series. This series/habitat can include North American Big Game, African, Marine, Predator, Waterfowl, Upland Game Bird, and the like. The selections are varied and limitless. While the invention has been described in terms of a wildlife theme, one having ordinary skill in the art would recognize that other themes having a series of coordinating sounds could be made available. These other themes can include musical instruments, sports, “girl power”, cartoon characters, and the like.

The invention has been described in such full, clear, concise, and exact terms so as to enable any person skilled in the art to which it pertains to make and use the same. It should be understood that variations, modifications, equivalents and substitutions for components of the specifically described embodiments of the invention may be made by those skilled in the art without departing from the spirit and scope of the invention as set forth in the appended claims. Persons who possess such skill will also recognize that the foregoing description is merely illustrative and not intended to limit any of the ensuing claims to any particular narrow interpretation.

I claim:

1. An alarm clock for emitting a predetermined sound alarm according to a predetermined time, said alarm clock comprising:
(a) a housing;
(b) a clock mechanism and clock display face contained within said housing, said clock mechanism including means to generate a signal at said predetermined time;
(c) a sound generating circuit contained within said housing and connected to said clock mechanism to generate said predetermined sound at said predetermined time as controlled by said clock mechanism;
(d) means associated with said sound generating circuit for changing said predetermined sound to one of a predetermined series of different sounds; and
(e) a power source associated with said clock mechanism and said sound generating circuit for operating said alarm clock.

2. An alarm clock as recited in claim 1 including means for disabling said sound alarm for a predetermined interval of time and means for reactivating said sound alarm at the conclusion of said interval of time.

3. An alarm clock as recited in claim 2 wherein said means for disabling and reactivating said sound alarm comprises a snooze button associated with a timing circuit.

4. An alarm clock as recited in claim 2 including means for automatically rolling through said predetermined series of sounds after each successive predetermined time interval.

5. An alarm clock as recited in claim 1 wherein said means associated with said sound generating circuit for changing said predetermined sound to one of said predetermined series of sounds comprises a knob for manually selecting a predetermined sound.

6. An alarm clock as recited in claim 1 wherein said means associated with said sound generating circuit for changing said predetermined sound to one of said predetermined series of sounds comprises a microprocessor chip embedded within said housing for automatically switching through said series of sounds.

7. An alarm clock as recited in claim 1 including an AM/FM radio located within said housing.

8. An alarm clock as recited in claim 1 including a volume control button for controlling the volume of said sound alarm.

9. An alarm clock as recited in claim 1 including means for changing said predetermined time of said alarm sound.

10. An alarm clock as recited in claim 1 wherein said power source comprises at least one battery.

11. An alarm clock as recited in claim 1 wherein said power source comprises a power cord capable of connecting with an electrical outlet.

12. An alarm clock as recited in claim 1 wherein said power source comprises a combination of a power cord connected with an electrical outlet and a back-up battery system capable of being activated due to an interruption of electrical power.

13. An alarm clock as recited in claim 1 including illuminating means for said clock display face.

14. An alarm clock for emitting a predetermined wildlife sound alarm according to a predetermined time, said alarm clock comprising:
(a) a housing;
(b) a clock mechanism and clock display face contained within said housing, said clock mechanism including means to generate a signal at said predetermined time;
(c) a sound generating circuit contained within said housing and connected to said clock mechanism to generate said predetermined wildlife sound at said predetermined time as controlled by said clock mechanism;
(d) means associated with said sound generating circuit for changing said predetermined wildlife sound to one of a predetermined series of wildlife sounds; and
(e) a power source associated with said clock mechanism and said sound generating circuit for operating said alarm clock.

15. An alarm clock as recited in claim 14 including means for disabling said wildlife sound alarm for a predetermined interval of time and means for reactivating said wildlife sound alarm at the conclusion of said interval of time.

16. An alarm clock as recited in claim 15 wherein said means for disabling and reactivating said wildlife sound alarm comprises a snooze button associated with a timing circuit.

17. An alarm clock as recited in claim 15 including means for automatically rolling through said predetermined series of wildlife sounds after each successive predetermined time interval.

18. An alarm clock as recited in claim 15 wherein said means associated with said sound generating circuit for changing said predetermined wildlife sound to one of said predetermined series of wildlife sounds comprises a knob for manually selecting a predetermined wildlife sound.

19. An alarm clock as recited in claim 15 wherein said means associated with said sound generating circuit for changing said predetermined wildlife sound to one of said predetermined series of wildlife sounds comprises a microprocessor chip embedded within said housing for automatically switching through said series of wildlife sounds.

20. An alarm clock as recited in claim 15 wherein said housing is designed so as to resemble the habitat of said predetermined series of wildlife sounds.
